(19) United States
(12) Patent Application Publication
(10) Pub. No.: US 2011/0015070 A1
(43) Pub. Date: Jan. 20, 2011

(54) Composition for Improving Plant Growth and Yield and Method for Using Same

(76) Inventor: Benjamin Bogomolny, Jerusalem (IL)

Correspondence Address: Daniel Feigelson, Lev Hamada Building, Second Floor, 7 Oppenheimer St., Rehovot, IL

(21) Appl. No.: 12/518,106

(22) PCT Filed: Dec. 6, 2007
(86) PCT No.: PCT/US07/86566

§ 371 Date: Jun. 7, 2009

Related U.S. Application Data
(60) Provisional application No. 60/872,981, filed on Dec. 6, 2006.

(30) Foreign Application Priority Data
Dec. 6, 2007 (US) PCT/US2007/086566

(51) Int. Cl. A01N 37/00; A01P 21/00

(52) U.S. Cl. 504/142

(57) ABSTRACT

There is disclosed a composition comprising the essential oils bergamot oil, neroli oil and patchouli oil, and optionally a carrier oil and/or water, as well as a method for using the composition to improve plant growth and/or yield. Other embodiments are also disclosed.

### RELATED APPLICATION INFORMATION

This application claims priority from U.S. Provisional Application Ser. No. 60/872,981, filed Dec. 6, 2006, the contents of which are incorporated herein by reference.

### BACKGROUND

Essential oils are made from plants through distillation or are obtained by simple pressure. As is known in the art, an essential oil is a concentrated, hydrophobic liquid that contains volatile aroma compounds from plants, which are themselves called aromatic herbs or aromatic plants. Essential oils are also known as volatile or ethereal oils, or sometimes simply referred as the “oil of” the plant material from which the oil were extracted, such as oil of clove. The term essential indicates that the oil carries a distinctive scent (essence) of the plant, not that it is an especially important or fundamental substance. Essential oils do not as a group have any specific chemical properties in common, beyond conveying characteristic fragrances. They are not to be confused with essential fatty acids.

Essential oils are generally extracted by distillation. Other processes for obtaining essential oils include expression and solvent extraction. Essential oils are used in perfumes and cosmetics, for flavoring food and drink, and for scenting incense and household cleaning products.

Various essential oils have been used medicinally at different periods in history. Medical applications proposed by those who sell medicinal oils vary from skin treatments to remedies for cancer, and are often based on historical use of these oils for these purposes.

Interest in essential oils has revived in recent decades, with the popularity of aromatherapy, a branch of alternative medicine which claims that the specific aromas carried by essential oils have curative effects. The essential oils used in aromatherapy are volatilized or diluted in a carrier oil and used in massage, or burned as incense, for example.

Today, most common essential oils, such as lavender, peppermint, and eucalyptus, are distilled. Raw plant material, consisting of the flowers, leaves, wood, bark, roots, seeds, or peel, depending on the specific plant, is used in the distillation. Most oils are distilled in a single process.

Most citrus peel oils are usually expressed mechanically, or cold-pressed. Due to the large quantities of oil in citrus peel and the relatively low cost to grow and harvest the raw materials, citrus-fruit oils are cheaper than most other essential oils.

Because of their concentrated nature, essential oils generally should not be applied directly to the skin in their undiluted or “neat” form. Some can cause severe irritation or provoke an allergic reaction. Instead, for handling essential oils should be blended with a vegetable carrier oil (sometimes referred to as a base or “fixed” oil) before being applied to skin. Common carrier oils include olive, almond, hazelnut and grapeseed. Essential oils are usually disersed in the carrier oil in a ratio of <10% w/w, commonly in a ratio of 0.5-3% w/w, depending on the purpose for which the oil will be used. Some essential oils, including many of the citrus peel oils, are photosensitizers, increasing the skin's reaction to sunlight and making it more likely to burn.

Increasing plant growth and crop yield is a long-standing goal of agriculture.

### BRIEF STATEMENT OF THE INVENTION

There is provided, in accordance with an embodiment of the invention, a composition comprising the essential oils bergamot oil, neroli oil and patchouli oil. In some embodiments, the composition comprises a carrier oil. In some embodiments, the composition comprises a preservative oil. In some embodiments, the composition comprises water. In some embodiments, the composition is substantially free of other essential oils. In some embodiments, the composition is substantially free of other ingredients.

In some embodiments, the weight ratio of bergamot, neroli and patchouli oils is 1:1:1. In some embodiments, no one of the three essential oils is present in a weight ratio which is more than ten times the amount of either of the other essential oils.

In some embodiments, the total amount of the bergamot, neroli and patchouli oils relative to water is less than 1 wt.%. In some embodiments, the total amount of the three essential oils relative to water is less than 0.5 wt.%. In some embodiments, the total amount of the three essential oils relative to water is less than 0.1 wt.%.

In some embodiments, the amount of carrier oil is between 5 and 15% v/v relative to the water. In some embodiments, the amount of carrier oil is about 10% v/v relative to the water. In some embodiments, the carrier oil is selected from the group consisting of sunflower, soy and hazelnut oils.

In some embodiments, the preservative oil is wheat germ oil. In some embodiments, the wheat germ oil is present in an amount equal to about one third of the total amount of essential oils.

There is also provided, in accordance with an embodiment of the invention, a method for treating a plant to improve plant growth and/or to improve crop yield, comprising applying to a plant or to soil in which a plant is growing or in which a seed has been planted a composition in accordance with embodiments of the invention. In some embodiments of the invention, the composition is diluted in water prior to application.

In some embodiments, the plant is selected from the group consisting of lettuce, tomatoes, cucumbers, sage, lemon balm, common thyme, basil, mint, and roses.

There is also provided, in accordance with an embodiment of the invention, a kit, comprising a composition in accordance with an embodiment of the invention and instructions for applying the composition to a plant or to soil in which a plant is growing or in which a seed has been planted.

There is also provided, in accordance with an embodiment of the invention, a kit, comprising bergamot oil, neroli oil and patchouli oil, and instructions for making a composition in accordance with embodiments of the invention. In some embodiments, the instructions further instruct how to apply the composition to a plant or to soil in which a plant is growing or in which a seed has been planted.

### DETAILED DESCRIPTION

Bergamot oil is obtained from the bergamot (Citrus bergamia), a small and roughly pear-shaped citrus fruit indigenous to and grown mainly in Calabria, Italy. The oil is obtained by pressing from the rind of the fruit.

Neroli oil is a plant oil similar in scent to bergamot oil. It is obtained is from the flowers of the bitter orange tree (citrus aurantium, var. amara). The blossoms are gathered, usually by hand, in late April to early May. The oil is produced by water distillation, as the blossom is too fragile to endure steam distillation.

Patchouli (sometimes spelled patchouly or pachouli) oil is obtained by steam distillation from the dried leaves of the patchouli plant a bushy plant (Pogostemon patchouli or P. cahlin). Patchouli is a tropical member of the mint family, grown in the East and West Indies. Leaves are harvested several times a year, dried, and exported for distillation of the oil, although the highest quality oil is usually produced from fresh leaves, distilled close to the plantation. The patchouli plant is a bushy herb reaching 60-90 cm in height. It enjoys hot weather but not direct sunlight.

### Example 1—Production of Composition in Accordance With Embodiments of the Invention

Two drops of each of Bergamot, Neroli and Patchouli oils were added to 500 ml of water and 30 ml of sunflower oil. The essential oils were mixed in with the water and vegetable oil, with two drops of wheat germ oil added to preserve the composition. The result was a stock mixture of dilute a mixture of Bergamot, Neroli and Patchouli oils.

In use, the stock mixture may further diluted before application to plants. Thus, for example, 50 ml of stock mixture may be added to 8 to 10 liters of water, which may be used to water the plants as needed, which should be sufficient to water an area of approximately 18 square meters. It was found that was not necessary to re-mix the components of the stock mixture immediately prior to use.

### Example 2

This experiment was carried out in the summer in Jerusalem, Israel. Twenty seedling of iceberg lettuce (Lactuca sateva L.) were planted in each of three lots which were located in close proximity to one another. The plants in each lot were spaced 30 cm apart. In Lots 1 and 3, the soil was untreated; in Lot 2, compost was added. All three lots were watered as necessary in accordance with local weather conditions to ensure that all plants received sufficient water. Once a week, in addition to watering with untreated water, the plants in Lot no. 3 were treated with 10 liters water to which 50 ml of the composition of Example 1 had been added. The results of the experiment are set forth in the table below.

| | Average Height of Plants | | |
|---|---|---|---|
| Date | Lot 1 | Lot 2 | Lot 3 |
| June 8 | 10 cm | 10 cm | 10 cm |
| July 8 | 15 cm | 22 cm | 25 cm |

The number of plants that survived were: Lot 1-15; Lot 2-16; Lot 3-19. The dead plants were all infected with the fungus Fusarium oxysporum, which is common in the area where the experiment was conducted. None of the suriving plants were so infected.

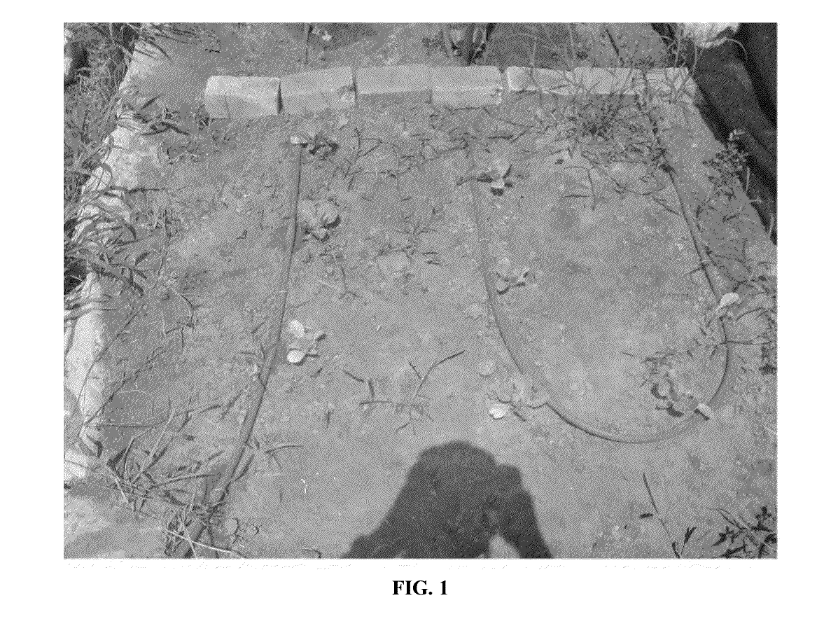

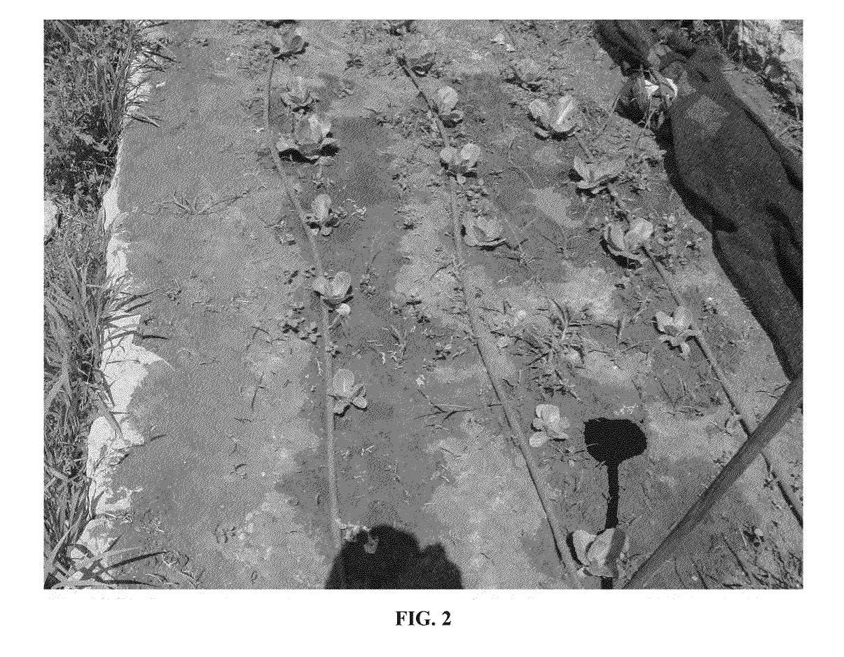

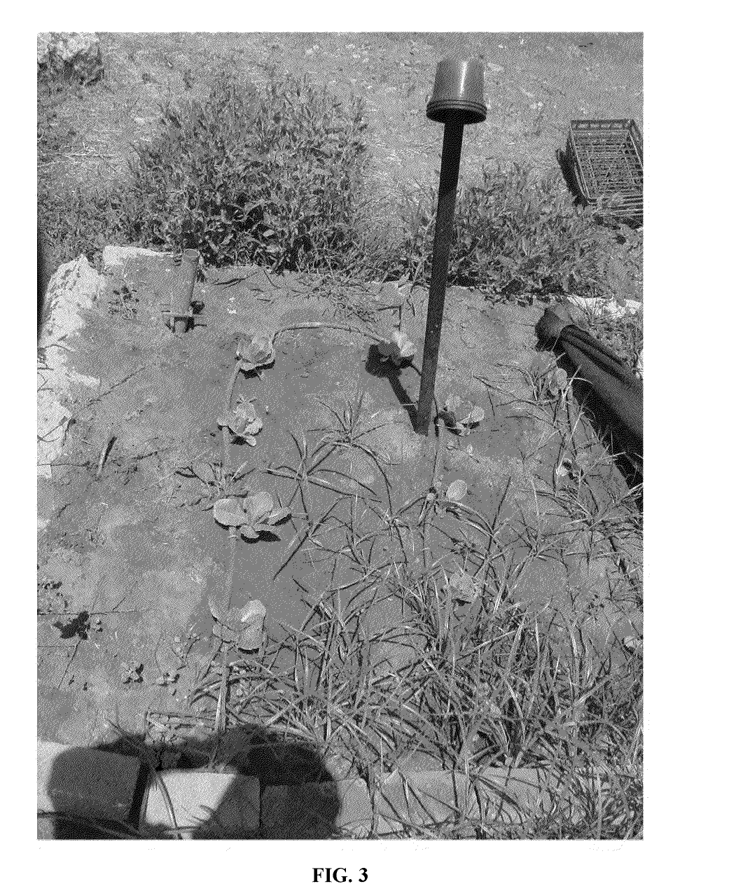

Photographs of the plants in Lots nos. 1, 2 and 3 respectively, taken four weeks after planting, are shown in FIGS. 1, 2 and 3 respectively.

The lettuce in Lot no. 3 was observed to taste less bitter than that of the lettuce in Lots no. 1 and no. 2 and the leaves of the lettuce in Lot no. 3 were observed to be more tender than those form Lots no. 1 and no. 2.

### Example 3

In March of the first year of the experiment, seeds of sage (salvia officinalis), lemon balm (Melissa officinalis) and common thyme (thymus vulgaris) were planted on a small plot of land in Jerusalem, Israel. There was a very thin layer of soil consisting mainly of clay and pebbles on bedrock. No fertilizers were added. In two to three weeks the seeds sprouted, but in spite of the fact that they received plenty of water and grew throughout the entire year, the plants reached not more than 8 to 10 cm in height.

The following March, these same plants were watered with solution of prepared in accordance with Example 1. Three weeks later the sage grew into a bush of 30 to 40 cm in height. By the end of the summer the height of the sage was 55 cm, lemon balm was 60 cm and common thyme was 62 cm high.

### Example 4

One summer, cucumber seeds were planted in Jerusalem, Israel and a composition prepared in accordance with Example 1 was used 2 to 3 times per week. Despite hot weather with temperatures rising as high as 37 degrees Celsius, the crop was good, with the 12 plants yielding a total of 2-3 kg per week of cucumbers. In comparison, cucumbers planted in the same area and under the same conditions two years later, which were not treated with the composition of Example 1, developed flowers, but did not yield cucumbers.

### Example 5

In consecutive summers, two types of tomato seeds were planted and treated regularly with a composition as described in Example 1:

1. Beefsteak tomatoes (lycopersicon lycopersicum)

2. Big Boy tomatoes (hybrid/pole).

As is known in the art, both of these types of tomatoes are meant to be grown in a high humidity climate. Despite the fact that in this example, the tomatoes were planted in an arid, semi-desert climate (Jerusalem, Israel) they produced a good crop. Specifically, the Big Boy tomato seeds that were exposed to direct sunlight grew into bushes of approximately 180 cm height each, each of which produced more than one hundred tomatoes weighing up to 150 grams each.

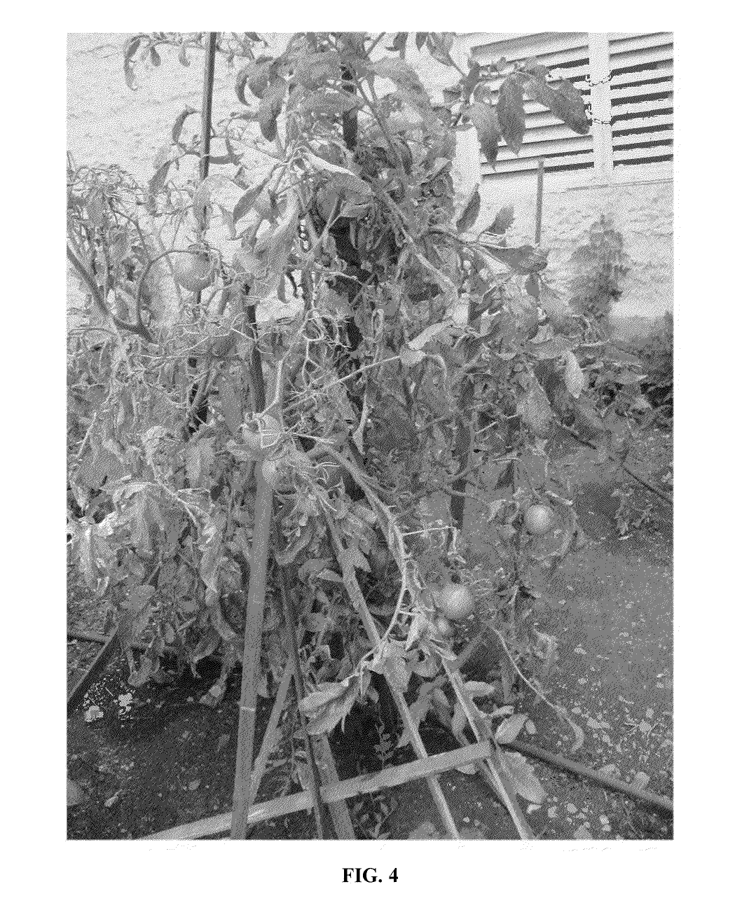

The Beefsteak tomato seeds that were exposed to direct sunlight grew into bushes of approximately 150 cm in height each, each of which produced more than 40 tomatoes weighing up to 320 grams each. A photograph of such a plant is shown in FIG. 4.

Both types of treated tomato plants were observed to be disease free.

The invention has been described in detail with particular reference to some embodiments thereof, but it will be understood by those skilled in the art that variations and modifications can be effected within the spirit and scope of the invention.

1. A composition comprising the essential oils bergamot oil, neroli oil and patchouli oil.

2. A composition according to claim 1, further comprising at least one of (a) a carrier oil, (b) a preservative oil, and (c) water.

3. A composition according to claim 2 wherein said carrier oil is selected from the group consisting of sunflower, soy and hazelnut oils.

4. A composition according claim 2, which comprises a preservative oil.

5. (canceled)

6. A composition according to claim 2 which comprises water and wherein the total amount of said essential oils relative to said water is less than 1 wt. %.

7. (canceled)

8. (canceled)

9. A composition according to claim 2, wherein the composition is substantially free of other essential oils.

10. A composition according to claims 2, wherein the composition is substantially free of other ingredients.

11. A composition according to claim 2 wherein no one of said essential oils is present in an amount which is more than ten times by weight the amount of either of the other essential oils.

12. A composition according to claim 11, wherein the weight ratio of said bergamot, neroli and patchouli oils is 1:1:1.

13. A composition according to claim 2 wherein the amount of said carrier oil is between 5 and 15% v/v relative to said water.

14. A composition according to claim 13 wherein the amount of said carrier oil is about 10% v/v relative to said water.

15. A composition according to claim 4 wherein said preservative oil is wheat germ oil.

16. A composition according to claim 15 wherein said I wheat germ oil is present in an amount equal to about one third of the total amount of said essential oils.

17. A method for treating a plant to improve plant growth and/or to improve crop yield, comprising applying to a plant or to soil in which a plant is growing or in which a seed has been planted a composition according to claims.

18. A method according to claim 17 wherein the composition is diluted in water prior to application to said plant or said soil.

19. A method according to claim 18, wherein said plant is selected from the group consisting of lettuce, tomatoes, cucumbers, sage, lemon balm, common thyme, basil, mint, and rose.

20. A kit comprising a composition according to claim 2 and instructions for applying said composition to a plant or to soil in which a plant is growing or in which a seed has been planted.

21. A kit comprising bergamot oil, neroli oil and patchouli oil, and instructions for making a composition in according to claim 2.

22. A kit according to claim 21, wherein said instructions further instruct how to apply the composition to a plant or to soil in which a plant is growing or in which a seed has been planted.

23. A composition according to claim 1, further comprising a carrier oil, a preservative oil and water, wherein the composition is substantially free of other essential oils.
